(19) United States
(12) Patent Application Publication
(10) Pub. No.: US 2017/0140042 A1
(43) Pub. Date: May 18, 2017

(54) EXTRACTING CONTENT FROM MULTILINGUAL DIAGNOSTIC RECORDS

(71) Applicant: GM Global Technology Operations LLC, Detroit, MI (US)

(72) Inventors: Dnyanesh G. RAJPATHAK, Troy, MI (US); Sagar SONTAKKE, Maharashtra (IN); Soumen DE, Bangalore (IN)

(21) Appl. No.: 14/939,346

(22) Filed: Nov. 12, 2015

(51) Int. Cl. G06F 17/30; G07C 5/08; G06N 99/00; G07C 5/02

(52) U.S. Cl. CPC G06F 17/30705; G07C 5/02; G07C 5/08; G06F 17/30117; G06N 99/005

(57) ABSTRACT

A system and method of analyzing vehicle diagnostic records using a trained database includes: receiving one or more vehicle diagnostic records; determining the number of words in each vehicle diagnostic record; accessing a probable or predominant classification from the trained database for one or more word positions; and classifying the word positions based on the probably or predominant classification.

### TECHNICAL FIELD

The present invention relates to vehicle operation and, more particularly, to analyzing vehicle diagnostic records reflecting vehicle operation or service.

### BACKGROUND

Vehicle owners occasionally have problems with their vehicles that can be resolved by a visit to a vehicle service center. There, a vehicle technician can listen to vehicle owners explain the symptoms of the problem, observe the problem themselves, diagnose the cause of the problem, and provide a solution. As part of maintaining a record of service for a vehicle, the vehicle technician generally writes down the part(s) of the vehicle affected by the problem, the symptom(s) of the problem the vehicle owner or technician observed, and the action(s) taken to resolve the problem in a vehicle diagnostic record.

Apart from providing a record of vehicle service, the vehicle diagnostic records for a large number of serviced vehicles can be used to gather information about vehicle operation and/or service for a fleet of vehicles. However, as both the number of vehicles and the geographic area where the vehicles are used increases, so too does the complexity of analyzing the vehicle diagnostic records for those vehicles. For example, a particular vehicle model may be deployed in a large area encompassing different countries where vehicle technicians speak different languages. That is, one country may have vehicle technicians that speak different languages or the vehicle may be sold in different countries each of which has its own language. The vehicle technicians servicing the same model vehicle over a large geographic area may create vehicle diagnostic records in different languages. When the vehicle diagnostic records are received in different languages, human operators competent in a particular language analyze the content of the vehicle diagnostic records written in that language and determine what the records say.

But this can create a number of problems. Relying on human interpretation of words or sentences can introduce unwanted error into the analysis of the vehicle diagnostic records. Different human operators can interpret the same vehicle diagnostic record in different ways. These variable interpretations add undesirable uncertainty to the analysis of the vehicle diagnostic records. Also, the use of human translators to initially translate data can result in inefficiencies when processing large amounts of vehicle diagnostic records. And the words or sentences included in the vehicle diagnostic record may convey different information depending on the language. Thus, it would be helpful to process vehicle diagnostic records for a fleet of vehicles in a way that identifies words or sentences without regard for the language in which the vehicle diagnostic records are maintained.

### SUMMARY

According to an embodiment of the invention, there is provided a method of training a database to analyze vehicle diagnostic records. The method includes receiving a plurality of vehicle diagnostic records; separating the content of the vehicle diagnostic records into discrete words each of which is identified by a word position within the vehicle diagnostic record; classifying each discrete word; determining for one or more word positions within the plurality of vehicle diagnostic records that it predominantly includes one classification; and storing the classification for one or more word positions in the database.

According to another embodiment of the invention, there is provided a method of training a database to analyze vehicle diagnostic records. The method includes receiving a plurality of vehicle diagnostic records at the database; separating the content of the vehicle diagnostic records into discrete words each of which is identified by a word position within the vehicle diagnostic record; classifying each discrete word; determining a probable classification for one or more word positions within the plurality of vehicle diagnostic records; determining whether one or more word positions have a plurality of probable classifications; identifying a predominant classification among the plurality of probable classifications for the one or more word position(s); and storing the predominant classification for the one or more word position(s) at the database.

According to another embodiment of the invention, there is provided a method of analyzing vehicle diagnostic records using a trained database. The method includes receiving one or more vehicle diagnostic records; determining one or more word positions for each vehicle diagnostic record; accessing a classification from the trained database for the one or more word positions; and classifying the one or more word positions based on the classification.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a flow chart depicting an embodiment of a method of training a database to analyze vehicle diagnostic records; and

FIG. 3 is a flow chart depicting an embodiment of a method of analyzing vehicle diagnostic records using a trained database.

### DETAILED DESCRIPTION OF THE ILLUSTRATED EMBODIMENTS

The system and method described below trains a database for processing vehicle diagnostic records and processes vehicle diagnostic records using the database. Vehicle diagnostic records include text describing vehicle service provided for a particular vehicle. As pointed out above, this text can include a wide variety of different languages. Rather than manually examine each vehicle diagnostic record and identify words in the vehicle diagnostic record according to a particular classification, word positions in the vehicle diagnostic record can be classified according to what type of word is most likely to be found in a particular position in the vehicle diagnostic record. That is, when a group of vehicle diagnostic records are reviewed as part of a database training phase, the number of words of each vehicle diagnostic record in the group can be calculated and a word position assigned to each of the number of words. Each word position in the vehicle diagnostic records can then be classified, such as by whether the word relates to a part, a symptom, or an action. As more and more vehicle diagnostic records are analyzed, patterns emerge for vehicle diagnostic records having differing amounts of words.

At the conclusion of the training period, the database can store probable classifications for word positions of vehicle diagnostic records having different quantities of words. Later, when subsequent vehicle diagnostic records are analyzed using the trained database, the records can be processed without regard to the language of the text. Vehicle diagnostic records containing Korean, Thai, or Chinese characters can be processed by users who do not understand those languages. Each vehicle diagnostic record can be processed to determine the number of words it includes. The database may then be accessed and one or more probable classifications for word positions in the vehicle diagnostic record can be determined based on the number of words in the vehicle diagnostic record. At least some of the words in each vehicle diagnostic record can then be classified according to the probable classification in the database.

### Communications System—

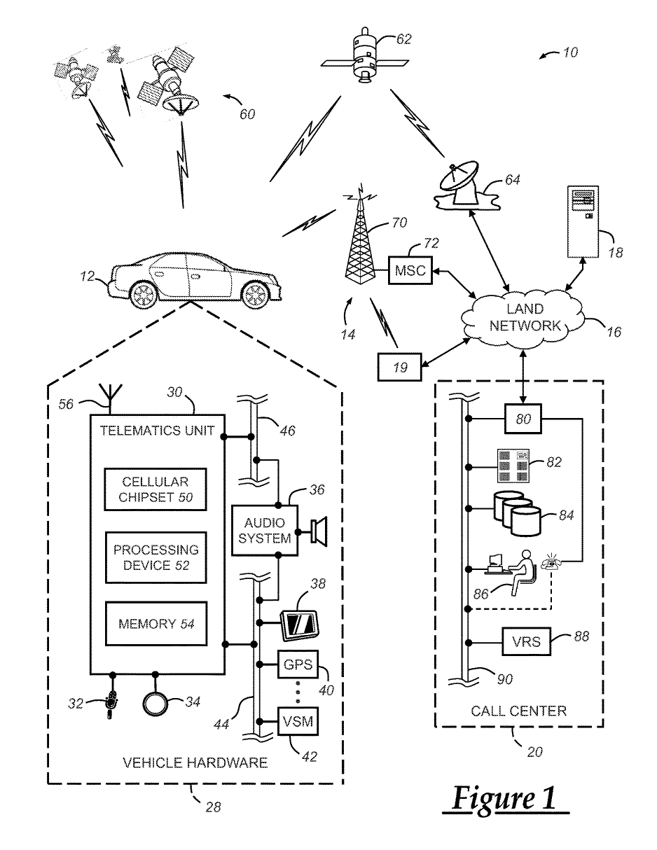

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, a vehicle service center 19, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™, Wi-Fi direct, Bluetooth, or near field communication (NFC). When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

The service center 19 is a location where vehicle owners bring the vehicle 12 for routine maintenance or resolution of vehicle trouble. There, vehicle technicians can observe the vehicle and analyze vehicle trouble using a variety of tools, such as computer-based scan tools that obtain diagnostic trouble codes (DTCs) stored in the vehicle 12. As part of maintaining the vehicle 12 or analyzing vehicle trouble, vehicle technicians may memorialize the analysis in a vehicle diagnostic report, which can include the parts affected, the symptoms observed or reported, and the actions carried out by the vehicle technicians. The vehicle diagnostic records for vehicles serviced by the service center 19 can be stored at the center 19 or transmitted to a central facility, such as the computer 18 or call center 20, via the wireless carrier system 14 and/or the land network 16.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Method—

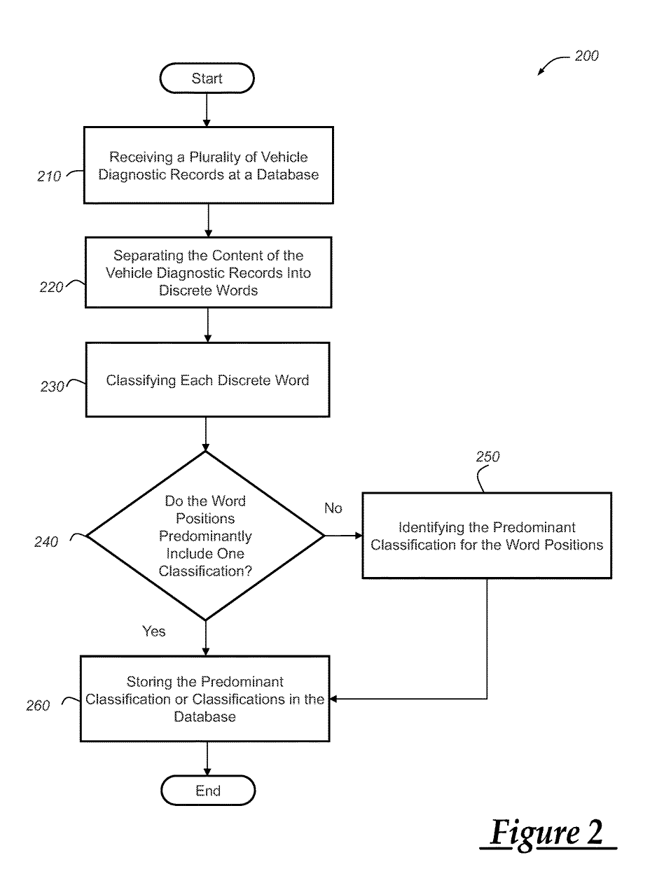

Turning now to FIG. 2, there is shown a method 200 of training a database to process vehicle diagnostic records. The method 210 begins by receiving a plurality of vehicle diagnostic records at the database. Vehicle diagnostic records can include unstructured text that describes the service performed for the vehicle 12. Vehicle technicians working at a vehicle service center can record in narrative form the service performed for the vehicle 12. In some implementations, the vehicle diagnostic record can include words in the text that are categorized as a part, a symptom, or an action. A part describes an element of the vehicle 12 that may be affected by a problem. The part could be tangible, such as modules, electrical connectors or pins, a power window motor, vehicle brake pads, or an exterior light bulb, to name a few examples. Or the part could be intangible, such as vehicle software. Symptoms can describe one or more problems afflicting the vehicle 12. For instance, the symptom words can include descriptors such as “squealing,” “inoperative,” “malfunctioning,” “pulsating,” “noisy” or other similar language. Symptoms may also include diagnostic trouble codes as well. And the action words can describe what the vehicle technician did to remedy the problem. The action words can include words like “replaced,” “lubricated,” “adjusted,” or “calibrated.” In one example, vehicle technician may service a 2011 Chevrolet Malibu and as part of the service create a vehicle diagnostic record that states “THE VEHICLE BRAKES ARE SQUEALING AND PULSATING; REPLACED THE BRAKE PADS AND FRONT ROTORS.” In this example, the vehicle diagnostic report can identify the year and make of the vehicle 12 as well as include parts (VEHICLE BRAKES; FRONT ROTORS), symptoms (SQUEALING; PULSATING), and actions (REPLACED). The part words, symptom words, and action words specifically identified above have been provided as examples and are not a comprehensive list of all the potential words that can be classified as parts, symptoms, or actions and it should be appreciated that other possibilities exist. Each of the part words, symptom words, and action words can relate to each other.

Vehicle diagnostic records can be generated from a fleet of vehicles and transmitted to a central facility where the records can be processed. Vehicle manufacturers sell their vehicles to many people or entities in a wide variety of geographic areas. In each of the geographic areas, the vehicle service facility 19 can provide diagnostic service to the vehicles 12. There, vehicle technicians can perform vehicle service and memorialize the service in a vehicle diagnostic record by describing the symptoms of the problem, the parts affected, or the actions carried out to end the symptoms and fix the part. The vehicle diagnostic record can include words that describe the parts, the symptoms, and the actions involved in servicing the vehicle 12. Each vehicle diagnostic record can be transmitted from a vehicle service facility to a central facility, such as the computer 18 or the call center 20, where the records are aggregated and either used to train a database or processed using the trained database. However, the computing hardware capable of carrying out the training and testing phases of vehicle diagnostic record analysis with respect to the database could be implemented in a wide variety of locations. In one embodiment, the methods described herein can be executed by a personal computer (PC) having a 2.8 GHz Intel Core i7 processor operating Windows 7 64 bit operating system with 32 GB of RAM. The database discussed herein as well as dictionaries accessed as part of training or using the database can be stored in computer-readable memory devices, such as the PC hard drive, and accessed at the direction of the processor. The method 200 proceeds to step 220.

At step 220, the content of the vehicle diagnostic records is separated into discrete words each of which is identified by a word position within the vehicle diagnostic record. The words in the vehicle diagnostic record can be identified according to its position relative to the other words in the vehicle diagnostic record, which can be carried out by determining how many words are included in a particular vehicle diagnostic record and assigning a numerical value to each word in the text of the vehicle diagnostic record reflecting the position of one word relative to the other words in the vehicle diagnostic record. For instance, the first three words of a vehicle diagnostic record can be labeled word one, word two, and word three, respectively, each indicating a word position within the vehicle diagnostic record. This numbering pattern continues until all of the words in the vehicle diagnostic record are assigned a number. For instance, in a twenty-word vehicle diagnostic record, word number ten is located before word number eleven and after number nine. It is possible to begin numbering using any number (e.g., 0 or 1) and continue sequentially for each word in the vehicle diagnostic record.

In some implementations, the vehicle diagnostic records can also be pre-processed to remove unnecessary content. This pre-processing can include removal of any stop words or special characters included in the vehicle diagnostic record. Special characters include the English equivalent of exclamation points, hyphens, and quotation marks, while stop words can include the English equivalent of articles, such as “the,” “an,” or “and.” While deleting stop words, they can be reviewed to ensure that the stop words are not necessary to maintain the original meaning of the vehicle diagnostic record. For example, in the example “PCM is not working” the terms “is” and “not” may be stop words in other contexts but are not deleted in this context to avoid altering the meaning of a text snippet. Pre-processing can occur before the vehicle diagnostic record is separated into discrete words. The pre-processing can be carried out by comparing character strings found in the vehicle diagnostic record with words included in a dictionary. Character strings can refer to a plurality of the individual characters that comprise a language, such as letters in English or individual Chinese language characters, that occur in order. In English, a character string could include the letters T-H-E comprising the article “the.” When a match between the character strings in the vehicle diagnostic record and the dictionary is found with a sufficient degree of confidence (e.g., above a 95% confidence threshold), then the character strings may not comprise a stop word or special character. However, if the string of characters in the vehicle diagnostic record is not found in the dictionary with a sufficient degree of confidence, then the string of characters may be classified as a stop word or special character and deleted from the vehicle diagnostic record. Dictionaries can be created to include particular words commonly found in vehicle diagnostic records (e.g., “brakes”) and exclude stop words (e.g., “the”). By controlling the content of the dictionary, stop words such as “the” can be identified by its absence from the dictionary. The method 200 proceeds to step 230.

At step 230, each discrete word in the vehicle diagnostic record can be classified. The discrete words in the vehicle diagnostic record can be compared with a dictionary that includes words categorized according to whether the word relates to a part, a symptom, or an action. A dictionary of words can be created that includes commonly-used words that describe either a part, a symptom, or an action. When the discrete words in each vehicle diagnostic record are analyzed, the dictionary can be searched to determine if a match exists. If so, the category the word is stored with in the dictionary can be determined and used to classify the discrete word in the vehicle diagnostic record. This process can be repeated until each word in the vehicle diagnostic record is categorized as a part, a symptom, or an action. The method 200 proceeds to step 240.

At step 240, one or more word positions within the vehicle diagnostic records are analyzed to determine whether they predominantly include one classification. As a statistically significant number of vehicle diagnostic records are analyzed, the frequency with which words having a particular classification appear is determined for particular word positions in vehicle diagnostic records having differing quantities of words. A confidence threshold can be established to determine whether a word position is predominantly one classification. When the percentage of words at one or more particular word positions are classified according to one type of classification at a rate above the confidence threshold, the word positions are labeled as including that type of classification.

For example, if five hundred vehicle diagnostic records are analyzed and more than 60% of the words at positions number four through six are classified as parts, the database can be instructed to thereafter classify words four through six as “parts” for the vehicle diagnostic records it subsequently analyzes. And the database can be instructed differently depending on the amount of words included in the vehicle diagnostic reports. Using the last example, it may be determined that more than 60% of vehicle diagnostic reports having twenty-five words include “part” words in word positions four through six. But when analyzing vehicle diagnostic reports having different amounts of words, different word positions may be characterized as “parts,” “symptoms,” and “actions.” In another example, with respect to vehicle diagnostic reports that are thirty-eight words long, word positions three through five may be classified as “parts” at a rate above the threshold (e.g., more than 60% of the time). And word position 7 can be classified as a symptom word. If the analyzed vehicle diagnostic records do not meet the threshold that indicates a predominant classification for one or more word positions, the method 200 proceeds to step 250. Otherwise, the method 200 proceeds to step 260.

At step 250, one or more word positions are determined to have a plurality of probable classifications. When more than one probable classification exists for one or more word positions, then a predominant classification can be identified among the plurality of probable classifications for the one or more word position(s). Some vehicle diagnostic records may have two or more classifications for one or more word positions. Analysis of a word position within a statistically significant number of processed vehicle diagnostic records may not result in one classification that is significantly more frequent than others. In one example, two or three classifications may occur with similar frequency. When such a condition exists, the relative probabilities of each classification for each word position can be calculated and compared. The highest relative probability among the classifications for a word position can then be used to select one of the classifications to assign to the word position. Table I below depicts word positions that have been classified as having two or three simultaneous classifications. The first column of the table indicates the length, in words, of vehicle diagnostic records and the subsequent columns indicate the word position or word position ranges that share the classifications. The classifications are “action-part,” “action-symptom,” “part-symptom,” and “action-part-symptom.”

TABLE I

| LENGTH | | | | | | | | | | |
|---|---|---|---|---|---|---|---|---|---|---|
| | ACTION - PART | | | | | | | | | |
| 25 | 2-3 | 8-9 | 3-4 | 10-11 | 14-15 | 20-21 | 7-8 | — | — | — |
| 26 | 7-9 | 5-6 | 9-11 | 14-15 | 2-6 | — | — | — | — | — |
| 44 | 2-3 | 12-14 | 12-13 | 14-15 | 10-11 | 9-10 | 27-28 | 2-4 | 7-10 | 0-2 |
| 45 | 11-12 | 10-12 | 32-34 | 2-3 | 31-32 | 5-8 | 6-8 | 16-18 | 8-11 | 8-10 |
| 180 | 30-32 | — | — | — | — | — | — | — | — | — |
| 183 | 23-25 | 18-19 | — | — | — | — | — | — | — | — |
| 188 | 14-15 | — | — | — | — | — | — | — | — | — |
| 189 | 25-26 | — | — | — | — | — | — | — | — | — |
| 190 | 71-73 | 77-78 | 0-1 | — | — | — | — | — | — | — |
| | ACTION - SYMPTOM | | | | | | | | | |
| | 17-18 | 19-20 | 23-23 | — | — | — | — | — | — | — |
| | 23-24 | 9-10 | 23-23 | 15-16 | 5-5 | — | — | — | — | — |
| | 18-19 | 0-1 | 9-9 | 29-30 | 40-41 | 14-17 | 6-6 | 41-41 | 36-37 | 23-26 |
| | 27-27 | 39-40 | 27-30 | 5-5 | 21-24 | 42-42 | 34-35 | 35-36 | 41-41 | 41-42 |
| | — | — | — | — | — | — | — | — | — | — |
| | 157-158 | 115-116 | — | — | — | — | — | — | — | — |
| | — | — | — | — | — | — | — | — | — | — |
| | 152-153 | — | — | — | — | — | — | — | — | — |
| | — | — | — | — | — | — | — | — | — | — |
| | PART - SYMPTOM | | | | | | | | | |
| | 21-22 | 15-17 | — | — | — | — | — | — | — | — |
| | 2-3 | 16-16 | 15-17 | 12-14 | — | — | — | — | — | — |
| | 19-21 | 26-27 | 18-20 | 16-16 | 33-33 | 28-30 | 13-16 | 24-26 | 39-41 | 37-38 |
| | 40-41 | 14-16 | 32-33 | 16-19 | 17-17 | 12-14 | 15-17 | 35-35 | 19-19 | 34-34 |
| | 91-93 | 175-177 | — | — | — | — | — | — | — | — |
| | 61-63 | — | — | — | — | — | — | — | — | — |
| | 52-54 | — | — | — | — | — | — | — | — | — |
| | 104-106 | 185-187 | — | — | — | — | — | — | — | — |
| | — | — | — | — | — | — | — | — | — | — |
| | ACTION - PART - SYMPTOM | | | | | | | | | |
| | 22-23 | 13-14 | 11-12 | 9-10 | 15-16 | — | — | — | — | — |
| | 13-14 | 3-4 | 12-13 | 10-11 | — | — | — | — | — | — |
| | 15-16 | 5-6 | 23-24 | 13-14 | 41-42 | 6-7 | 17-18 | 22-23 | 25-26 | 20-21 |
| | 27-28 | 14-15 | 25-26 | 16-17 | 21-22 | 23-24 | 18-19 | 13-14 | 22-23 | 40-43 |
| | — | — | — | — | — | — | — | — | — | — |
| | — | — | — | — | — | — | — | — | — | — |
| | — | — | — | — | — | — | — | — | — | — |
| | — | — | — | — | — | — | — | — | — | — |
| | 21-22 | — | — | — | — | — | — | — | — | — |

A Naïve Bayes model can be used to calculate the relative probabilities between different classifications at one or more word positions. The model can include the probability (PR) as follows: PR(part|word position), PR(symptom|word position), and PR(action|word position). These probabilities can be compared when multiple classifications for one or more word positions exist. The word position can then be labeled or assigned a classification associated with the highest relative probability.

In another implementation, the classifications of nearby word positions can be used to select a classification for a word position when more than one classification exists. A left and right context value can be established that defines how many word positions to the left and the right of a particular word position will be considered. For example, in a vehicle diagnostic record comprising 100 words, the word positions 59-61 may be initially classified as being a part, a symptom, and/or an action. The left and right context values can be set at three, which means that three word positions to the left and right of 59-61 will be analyzed (i.e., 56-58 and 62-64). A part context score, a symptom context score, and an action context score can be determined by counting the number of times the word positions to the left and the right of the analyzed word position are classified as a part, a symptom, or an action, respectively. The highest score can be determined and the analyzed word position can be classified based on the classification associated with the highest score. The method proceeds to step 260.

At step 260, the classification or predominant classification for one or more word positions is stored in the database. For vehicle diagnostic records having a particular number or quantity of words, one or more word positions are assigned a classification, such as part, symptom, or action. The database can then be partitioned according to word quantities and one or more word positions within vehicle diagnostic records having the word quantity can then be classified as a part, a symptom, or an action. The database can then be accessed during a use or testing phase that categorizes words found in subsequently analyzed vehicle diagnostic records. The method 200 then ends.

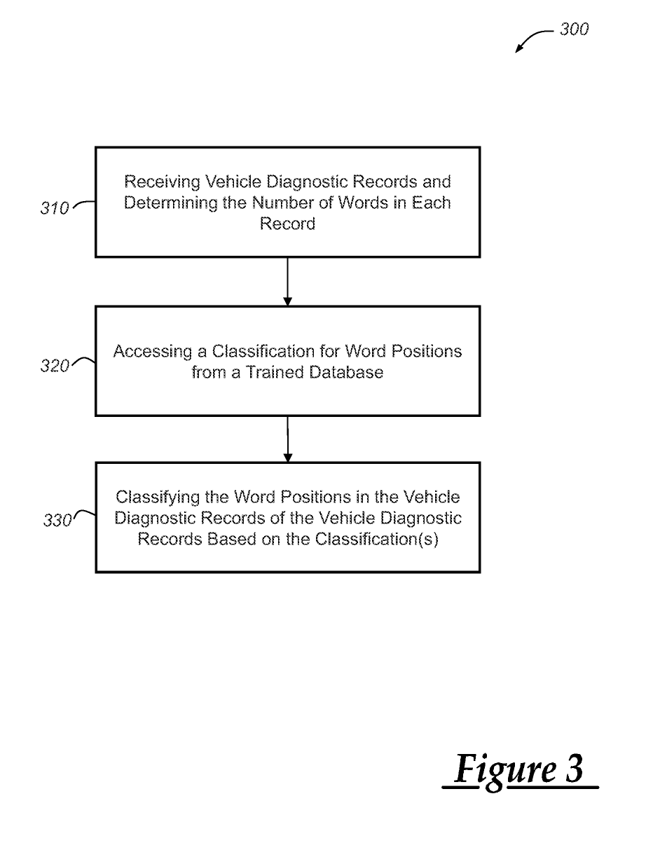

Turning to FIG. 3, a method 300 of analyzing vehicle diagnostic records is shown using the trained database. The method 300 begins at step 310 by receiving one or more vehicle diagnostic records and determining the number of words in each vehicle diagnostic record. As service centers create vehicle diagnostic records, the content of these records can be analyzed using the trained database. Words can be identified according to their position in the vehicle diagnostic record, extracted, and classified as being a part, a symptom, or an action. The vehicle diagnostic records can first be scanned to identify the number of words each record contains. Once the number of words has been determined, an entry is accessed in the trained database corresponding to the determined number of words. This can be carried out for each vehicle diagnostic record received and analyzed as part of the testing or use phase involving the trained database. The method 300 proceeds to step 320.

At step 320, a classification is accessed from the trained database for one or more word positions. For each vehicle diagnostic record, the trained database can provide the classification for each word position. In one example, a vehicle diagnostic record including 25 words can be analyzed. For 25 word vehicle diagnostic records, the trained database includes data indicating that certain word positions are classified as parts, symptoms or actions. For example, word positions 0-2, 15, and 6-7 can be classified as part words, symptom words, and action words, respectively. The method 300 proceeds to step 330.

At step 330, the word positions in the received vehicle diagnostics reports are classified based on the probably or predominant classification. The classifications obtained from the trained database can then be applied to the word positions of the vehicle diagnostic record. Continuing the example from step 320, the words found in positions 0-2, 15, and 6-7 in the 25 word vehicle diagnostic record can be extracted and stored as part words, symptom words, and action words, respectively. The part, symptom, and action words can be organized according to a wide range of different variables such as vehicle manufacturer, model, year of manufacture, options or features included with the vehicle to provide feedback regarding the performance of the vehicles as they are operated and after manufacture. The method 300 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of training a database to analyze vehicle diagnostic records, comprising the steps of:
(a) receiving a plurality of vehicle diagnostic records;
(b) separating the content of the vehicle diagnostic records into discrete words each of which is identified by a word position within the vehicle diagnostic record;
(c) classifying each discrete word;
(d) determining for one or more word positions within the plurality of vehicle diagnostic records that it predominantly includes one classification; and
(e) storing the classification for one or more word positions in the database.

2. The method of claim 1, wherein the vehicle diagnostic records include more than one language.

3. The method of claim 1, further comprising the step of pre-processing the vehicle diagnostic records.

4. The method of claim 3, wherein pre-processing further comprises removing one or more special characters or stop-words from the vehicle diagnostic records.

5. The method of claim 1, wherein the words are classified as a part, a symptom, or an action.

6. The method of claim 1, wherein step (d) further comprises establishing a threshold value.

7. A method of training a database to analyze vehicle diagnostic records, comprising the steps of:
(a) receiving a plurality of vehicle diagnostic records at the database;
(b) separating the content of the vehicle diagnostic records into discrete words each of which is identified by a word position within the vehicle diagnostic record;
(c) classifying each discrete word;
(d) determining a probable classification for one or more word positions within the plurality of vehicle diagnostic records;
(e) determining whether one or more word positions have a plurality of probable classifications;
(f) identifying a predominant classification among the plurality of probable classifications for the one or more word position(s); and
(g) storing the predominant classification for the one or more word position(s) in the database.

8. The method of claim 7, wherein the vehicle diagnostic records include more than one language.

9. The method of claim 7, further comprising the step of pre-processing the vehicle diagnostic records.

10. The method of claim 9, wherein pre-processing further comprises removing one or more special characters or stop-words from the vehicle diagnostic records.

11. The method of claim 7, wherein the probable classification comprises a part, a symptom, or an action.

12. The method of claim 7, wherein step (d) further comprises establishing a threshold value.

13. The method of claim 7, wherein the predominant classification is identified by processing the plurality of probable classifications with a Naïve Bayes model.

14. The method of claim 7, wherein the predominant classification is identified by establishing one or more context values.

15. A method of analyzing vehicle diagnostic records using a trained database, comprising the steps of:
(a) receiving one or more vehicle diagnostic records;
(b) determining one or more word positions for each vehicle diagnostic record;
(c) accessing a classification from the trained database for the one or more word positions; and
(d) classifying the one or more word positions based on the classification.

16. The method of claim 15, further comprising the step of determining the number of words in each vehicle diagnostic record.

17. The method of claim 15, wherein the word positions are classified as a part, a symptom, or an action.

18. The method of claim 15, wherein the vehicle diagnostic records include more than one language.

19. The method of claim 15, further comprising the step of pre-processing the vehicle diagnostic records.

20. The method of claim 15, wherein pre-processing further comprises removing one or more special characters or stop-words from the vehicle diagnostic records.
